(19) United States
(12) Patent Application Publication
(10) Pub. No.: US 2016/0345345 A1
(43) Pub. Date: Nov. 24, 2016

(54) METHODS AND APPARATUS FOR SIGNAL TIMING DETECTION, SHARING, AND INTERFERENCE AVOIDANCE

(71) Applicant: QUALCOMM Incorporated, San Diego, CA (US)

(72) Inventors: Rahul Malik, San Diego, CA (US); Hemanth Sampath, San Diego, CA (US); Tao Luo, San Diego, CA (US); Ahmed Kamel Sadek, San Diego, CA (US)

(21) Appl. No.: 15/154,481

(22) Filed: May 13, 2016

Related U.S. Application Data
(60) Provisional application No. 62/165,048, filed on May 21, 2015.

(51) Int. Cl. H04W 72/12; H04W 52/02; H04W 72/08; H04L 5/00; H04W 48/04; H04W 48/16

(52) U.S. Cl. CPC H04W 72/1215; H04W 48/04; H04W 48/16; H04W 72/082; H04L 5/0023; H04W 52/0216; H04W 84/12

(57) ABSTRACT

Certain aspects of the present disclosure relate to a methods and apparatus for wireless communication. In one aspect, a method of facilitating coexistence of wireless local area network (WLAN) devices and long term evolution unlicensed (LTE-U) devices in a communication network comprising a wireless device capable of both WLAN and LTE-U communication includes detecting one or more LTE-U networks and associated communication characteristics. The method further includes generating a LTE-U measurement report indicative of the LTE-U communication characteristics. The method further includes transmitting the LTE-U measurement report to at least one WLAN device.

### CLAIM OF PRIORITY UNDER 35 U.S.C. §119

The present application for patent claims priority to Provisional Application No. 62/165,048 entitled “METHODS AND APPARATUS FOR SIGNAL TIMING DETECTION, SHARING, AND INTERFERENCE AVOIDANCE” filed May 21, 2015, and assigned to the assignee hereof. Provisional Application No. 62/165,048 is hereby expressly incorporated by reference herein.

### FIELD

Certain aspects of the present disclosure generally relate to wireless communications, and more particularly, to methods and apparatus for signal timing detection, sharing, and interference avoidance.

### BACKGROUND

For increasing volume and complexity of information communicated wirelessly between multiple devices in a wireless communication system, the requirement for managing a level of acceptable interference continues to increase. Such devices may operate in close proximity to one another while operating over a common frequency spectrum in accordance with different communication standards. Two of such systems standards are commonly known as long-term evolution (LTE) and wireless local area network (WLAN). Use of a common frequency by different devices inherently creates the possibility of experiencing interference while such devices are accessing the communication resources. Certain governmental regulatory agency makes spectrum available for wireless services, including licensed and unlicensed spectrums. Generally, wireless communications over the licensed frequencies are limited to one or more particular use and location. The licensed frequency spectrum has generally been provided for Cellular Market Areas (CMAs). The frequency spectrum designated as “unlicensed” or “licensed-exempt,” allows the users to freely operate wireless devices while complying with certain technical requirements, including transmission power limits. Users of the unlicensed frequency spectrum do not have exclusive use of the spectrum and are subject to interference by other users.

Generally, the particulars of the system protocol for operating in the licensed and unlicensed frequency spectrums may be different. The LTE standard allows LTE devices to operate in both licensed and unlicensed frequency spectrums. The WLAN devices may also be operating in the same unlicensed frequency spectrum. The LTE devices operating in the unlicensed frequency spectrum are generally known as LTE-U devices. LTE-U and WLAN devices may utilize a common frequency spectrum at essentially the same time or overlapping time periods. To reduce and possibly avoid a level of interference experienced by LTE-U and WLAN devices operating in a common unlicensed frequency spectrum, there is a need for controlling and managing use of the wireless communication resources.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of facilitating coexistence of wireless local area network (WLAN) devices and long term evolution unlicensed (LTE-U) devices in a communication network including a wireless device capable of both WLAN and LTE-U communication. The method includes detecting one or more LTE-U networks and associated communication characteristics. The method further includes generating a LTE-U measurement report indicative of the LTE-U communication characteristics. The method further includes transmitting the LTE-U measurement report to at least one WLAN device.

In various embodiments, the WLAN device can use the LTE-U measurement report for one or more of: selecting an operating channel, determining LTE-U interference levels, channels, and/or duty cycles, ignoring errors at certain times while performing a rate adaptation, and scheduling high priority packets. In various embodiments, the WLAN device can receive another LTE-U measurement report. In various embodiments, the WLAN device aggregates the LTE-U measurement report and the other LTE-U measurement report into an aggregated LTE-U measurement report.

In various embodiments, the WLAN device can transmit the aggregated LTE-U measurement report to one or more other WLAN devices. In various embodiments, transmitting the LTE-U measurement report can be in response to a solicitation. In various embodiments, transmitting the LTE-U measurement report can be unsolicited.

In various embodiments, the transmitted LTE-U measurement report can be in a beacon or probe response frame. In various embodiments the LTE-U measurement report may be transmitted in an action-frame, a public action frame or any other frame with appropriate vendor specific information elements. In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time (which can also be referred to herein as an on-duration), CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the method can further include encoding the LTE-U measurement report in a vendor specific information element (IE). In various embodiments, the LTE-U measurement report can include LTE-U communication characteristics for more than one type of LTE-U network. In various embodiments, the method can further include limiting propagation of the LTE-U measurement report via a number of hops indicated in the LTE-U measurement report.

In various embodiments, the method can further include transmitting one or more capability indications including one or more of: a field indicating LTE-U awareness, and a field indicating LTE-U measurement capability. In various embodiments, the WLAN device implements one or more Channel Usage Beacon Signal (CUBS) detectors that can receive CUBS identifiers obtained from the LTE-U measurement report. In various embodiments, the transmitting can include broadcasting. In various embodiments, the transmitting can include transmitting to a particular device.

Another aspect provides another method of facilitating coexistence of wireless local area network (WLAN) devices and long term evolution unlicensed (LTE-U) devices in a communication network including a wireless device capable of both WLAN communication. The method includes receiving a LTE-U measurement report indicative of communication characteristics associated with LTE-U networks. The method further includes scheduling a WLAN communication based at least in part on the LTE-U measurement. The method further includes transmitting the WLAN communication.

In various embodiments, the WLAN device can include a station and can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the WLAN device can include an access point and can use the LTE-U measurement report for one or more of: selecting an operating channel, adjusting Target Beacon Transmit Time (TBTT) or Delivery Traffic Indication Message (DTIM) timing, scheduling off-channel operation, transmitting one or more frames during an LTE-U idle period, determining a rate adaptation, applying Unscheduled Automatic Power Save Delivery Coexistence (UAPSD) mechanisms, and scheduling channel sounding packets for transmit beam-forming or multi-user MIMO transmissions.

In various embodiments, the method can further include receiving another LTE-U measurement report. In various embodiments, the method can further include aggregating the LTE-U measurement report and the other LTE-U measurement report into an aggregated LTE-U measurement report. In various embodiments, the method can further include transmitting the aggregated LTE-U measurement report to one or more other WLAN devices.

In various embodiments, transmitting the aggregated LTE-U measurement report can be in response to a solicitation. In various embodiments, transmitting the aggregated LTE-U measurement report can be unsolicited. In various embodiments, transmitting the aggregated LTE-U measurement report can be in a beacon or probe response frame. In various embodiments, transmitting the aggregated LTE-U measurement report may be in an action-frame, a public action frame or any other frame with appropriate vendor specific information elements.

In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the method can further include encoding the aggregated LTE-U measurement report in a vendor specific information element (IE). In various embodiments, the LTE-U measurement report can include LTE-U communication characteristics for more than one type of LTE-U network. In various embodiments, the method can further include limiting propagation of the aggregated LTE-U measurement report via a number of hops indicated in the aggregated LTE-U measurement report.

In various embodiments, the method can further include transmitting a field indicating LTE-U awareness. In various embodiments, the method can further include providing CUBS identifiers obtained from the LTE-U measurement report to one or more Channel Usage Beacon Signal (CUBS) detectors. In various embodiments, the transmitting can include broadcasting. In various embodiments, the transmitting can include transmitting to a particular device.

Another aspect provides an apparatus configured to facilitate coexistence of wireless local area network (WLAN) devices and long term evolution unlicensed (LTE-U) devices in a communication network including a wireless device capable of both WLAN and LTE-U communication. The apparatus includes a processor configured to detect one or more LTE-U networks and associated communication characteristics. The one or more processors are further configured to generate a LTE-U measurement report indicative of the LTE-U communication characteristics. The apparatus further includes a transmitter configured to transmit the LTE-U measurement report to at least one WLAN device.

In various embodiments, the WLAN device can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the WLAN device can receive another LTE-U measurement report. In various embodiments, the WLAN device aggregates the LTE-U measurement report and the other LTE-U measurement report into an aggregated LTE-U measurement report.

In various embodiments, the WLAN device can transmit the aggregated LTE-U measurement report to one or more other WLAN devices. In various embodiments, transmitting the LTE-U measurement report can be in response to a solicitation. In various embodiments, transmitting the LTE-U measurement report can be unsolicited.

In various embodiments, transmitting the LTE-U measurement report can be in a beacon or probe response frame. In various embodiments, transmitting the LTE-U measurement report may be in an action-frame, a public action frame or any other frame with appropriate vendor specific information elements. In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the processor can be further configured to encode the LTE-U measurement report in a vendor specific information element (IE). In various embodiments, the LTE-U measurement report can include LTE-U communication characteristics for more than one type of LTE-U network. In various embodiments, the processor can be further configured to limit propagation of the LTE-U measurement report via a number of hops indicated in the LTE-U measurement report.

In various embodiments, the transmitter can be further configured to transmit one or more capability indications including one or more of: a field indicating LTE-U awareness, and a field indicating LTE-U measurement capability. In various embodiments, the WLAN device implements one or more Channel Usage Beacon Signal (CUBS) detectors that can receive CUBS identifiers obtained from the LTE-U measurement report. In various embodiments, the transmitter can be configured to transmit by broadcasting. In various embodiments, the transmitter can be configured to transmit by transmitting to a particular device.

Another aspect provides another apparatus configured to facilitate coexistence of wireless local area network (WLAN) devices and long term evolution unlicensed (LTE-U) devices in a communication network including a wireless device capable of both WLAN communication. The apparatus includes a receiver configured to receive a LTE-U measurement report indicative of communication characteristics associated with LTE-U networks. The apparatus further includes a processor configured to schedule a WLAN communication based at least in part on the LTE-U measurement. The apparatus further includes a transmitter configured to transmit the WLAN communication.

In various embodiments, the WLAN device can include wherein the apparatus can include a station and can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the apparatus can include an access point and can use the LTE-U measurement report for one or more of: selecting an operating channel, adjusting Target Beacon Transmit Time (TBTT) or Delivery Traffic Indication Message (DTIM) timing, scheduling off-channel operation, transmitting one or more frames during an LTE-U idle period, determining a rate adaptation, applying Unscheduled Automatic Power Save Delivery Coexistence (UAPSD) mechanisms, and scheduling channel sounding packets for transmit beam-forming or multi-user MIMO transmissions.

In various embodiments, the receiver can be configured to receive another LTE-U measurement report. In various embodiments, the processor can be further configured to aggregate the LTE-U measurement report and the other LTE-U measurement report into an aggregated LTE-U measurement report. In various embodiments, the transmitter can be further configured to transmit the aggregated LTE-U measurement report to one or more other WLAN devices.

In various embodiments, the transmitter can be configured to transmit the aggregated LTE-U measurement report in response to a solicitation. In various embodiments, the transmitter can be configured to transmit the aggregated LTE-U measurement report unsolicited. In various embodiments, the transmitter can be configured to transmit the aggregated LTE-U measurement report in a beacon or probe response frame. In various embodiments, transmitting the aggregated LTE-U measurement report may be in an action-frame, a public action frame or any other frame with appropriate vendor specific information elements.

In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the processor can be further configured to encode the aggregated LTE-U measurement report in a vendor specific information element (IE). In various embodiments, the LTE-U measurement report can include LTE-U communication characteristics for more than one type of LTE-U network. In various embodiments, the processor can be further configured to limit propagation of the aggregated LTE-U measurement report via a number of hops indicated in the aggregated LTE-U measurement report.

In various embodiments, the transmitter can be further configured to transmit a field indicating LTE-U awareness. In various embodiments, the processor can be further configured to provide CUBS identifiers obtained from the LTE-U measurement report to one or more Channel Usage Beacon Signal (CUBS) detectors. In various embodiments, the transmitter can be configured to transmit by broadcasting. In various embodiments, the transmitter can be configured to transmit by transmitting to a particular device.

Another aspect provides another apparatus for facilitating coexistence of wireless local area network (WLAN) devices and long term evolution unlicensed (LTE-U) devices in a communication network including a wireless device capable of both WLAN and LTE-U communication. The apparatus includes means for detecting one or more LTE-U networks and associated communication characteristics. The apparatus further includes means for generating a LTE-U measurement report indicative of the LTE-U communication characteristics. The apparatus further includes means for transmitting the LTE-U measurement report to at least one WLAN device.

In various embodiments, the WLAN device can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the WLAN device can receive another LTE-U measurement report. In various embodiments, the WLAN device aggregates the LTE-U measurement report and the other LTE-U measurement report into an aggregated LTE-U measurement report.

In various embodiments, the WLAN device can transmit the aggregated LTE-U measurement report to one or more other WLAN devices. In various embodiments, transmitting the LTE-U measurement report can be in response to a solicitation. In various embodiments, transmitting the LTE-U measurement report can be unsolicited.

In various embodiments, transmitting the LTE-U measurement report can be in a beacon or probe response frame. In various embodiments, transmitting the LTE-U measurement report may be in an action-frame, a public action frame or any other frame with appropriate vendor specific information elements. In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the apparatus can further include means for encoding the LTE-U measurement report in a vendor specific information element (IE). In various embodiments, the LTE-U measurement report can include LTE-U communication characteristics for more than one type of LTE-U network. In various embodiments, the apparatus can further include means for limiting propagation of the LTE-U measurement report via a number of hops indicated in the LTE-U measurement report.

In various embodiments, the apparatus can further include means for transmitting one or more capability indications including one or more of: a field indicating LTE-U awareness, and a field indicating LTE-U measurement capability. In various embodiments, the WLAN device implements one or more Channel Usage Beacon Signal (CUBS) detectors that can receive CUBS identifiers obtained from the LTE-U measurement report. In various embodiments, the means for transmitting can include means for broadcasting. In various embodiments, the means for transmitting can include means for transmitting to a particular device.

Another aspect provides another apparatus for facilitating coexistence of wireless local area network (WLAN) devices and long term evolution unlicensed (LTE-U) devices in a communication network including a wireless device capable of both WLAN communication. The apparatus includes means for receiving a LTE-U measurement report indicative of communication characteristics associated with LTE-U networks. The apparatus further includes means for scheduling a WLAN communication based at least in part on the LTE-U measurement. The apparatus further includes means for transmitting the WLAN communication.

In various embodiments, the apparatus can include a station and can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the apparatus can include an access point and can use the LTE-U measurement report for one or more of: selecting an operating channel, adjusting Target Beacon Transmit Time (TBTT) or Delivery Traffic Indication Message (DTIM) timing, scheduling off-channel operation, transmitting one or more frames during an LTE-U idle period, determining a rate adaptation, applying Unscheduled Automatic Power Save Delivery Coexistence (UAPSD) mechanisms, and scheduling channel sounding packets for transmit beam-forming or multi-user MIMO transmissions.

In various embodiments, the apparatus can further include receiving another LTE-U measurement report. In various embodiments, the apparatus can further include aggregating the LTE-U measurement report and the other LTE-U measurement report into an aggregated LTE-U measurement report. In various embodiments, the apparatus can further include means for transmitting the aggregated LTE-U measurement report to one or more other WLAN devices.

In various embodiments, transmitting the aggregated LTE-U measurement report can be in response to a solicitation. In various embodiments, transmitting the aggregated LTE-U measurement report can be unsolicited. In various embodiments, transmitting the aggregated LTE-U measurement report can be in a beacon or probe response frame. In various embodiments, transmitting the aggregated LTE-U measurement report may be in an action-frame, a public action frame or any other frame with appropriate vendor specific information elements.

In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the apparatus can further include means for encoding the aggregated LTE-U measurement report in a vendor specific information element (IE). In various embodiments, the LTE-U measurement report can include LTE-U communication characteristics for more than one type of LTE-U network. In various embodiments, the apparatus can further include means for limiting propagation of the aggregated LTE-U measurement report via a number of hops indicated in the aggregated LTE-U measurement report.

In various embodiments, the apparatus can further include means for transmitting a field indicating LTE-U awareness. In various embodiments, the apparatus can further include means for providing CUBS identifiers obtained from the LTE-U measurement report to one or more Channel Usage Beacon Signal (CUBS) detectors. In various embodiments, the means for transmitting can include means for broadcasting. In various embodiments, the means for transmitting can include means for transmitting to a particular device.

Another aspect provides a non-transitory computer-readable medium including code, capable of facilitating coexistence of wireless local area network (WLAN) devices and long term evolution unlicensed (LTE-U) devices in a communication network including a wireless device capable of both WLAN and LTE-U communication. When executed, the code causes an apparatus to detect one or more LTE-U networks and associated communication characteristics. The medium further includes code that, when executed, causes the apparatus to generate a LTE-U measurement report indicative of the LTE-U communication characteristics. The medium further includes code that, when executed, causes the apparatus to transmit the LTE-U measurement report to at least one WLAN device.

In various embodiments, the WLAN device can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the WLAN device can receive another LTE-U measurement report. In various embodiments, the WLAN device aggregates the LTE-U measurement report and the other LTE-U measurement report into an aggregated LTE-U measurement report.

In various embodiments, the WLAN device can transmit the aggregated LTE-U measurement report to one or more other WLAN devices. In various embodiments, transmitting the LTE-U measurement report can be in response to a solicitation. In various embodiments, transmitting the LTE-U measurement report can be unsolicited.

In various embodiments, transmitting the LTE-U measurement report can be in a beacon or probe response frame. In various embodiments, transmitting the LTE-U measurement report may be in an action-frame, a public action frame or any other frame with appropriate vendor specific information elements. In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the medium can further include code that, when executed, can cause the apparatus to encode the LTE-U measurement report in a vendor specific information element (IE). In various embodiments, the LTE-U measurement report can include LTE-U communication characteristics for more than one type of LTE-U network. In various embodiments, the medium can further include code that, when executed, can cause the apparatus to limit propagation of the LTE-U measurement report via a number of hops indicated in the LTE-U measurement report.

In various embodiments, the medium can further include code that, when executed, can cause the apparatus to transmit one or more capability indications including one or more of: a field indicating LTE-U awareness, and a field indicating LTE-U measurement capability. In various embodiments, the WLAN device implements one or more Channel Usage Beacon Signal (CUBS) detectors that can receive CUBS identifiers obtained from the LTE-U measurement report. In various embodiments, the transmitting can include broadcasting. In various embodiments, the transmitting can include transmitting to a particular device.

Another aspect provides another non-transitory computer-readable medium including code, capable of facilitating coexistence of wireless local area network (WLAN) devices and long term evolution unlicensed (LTE-U) devices in a communication network including a wireless device capable of both WLAN communication. The code, when executed, causes an apparatus to receive a LTE-U measurement report indicative of communication characteristics associated with LTE-U networks. The medium further includes code that, when executed, causes the apparatus to schedule a WLAN communication based at least in part on the LTE-U measurement. The medium further includes code that, when executed, causes the apparatus to transmit the WLAN communication.

In various embodiments, the apparatus can include a station and can use the LTE-U measurement report for one or more of: selecting an operating channel, determining LTE-U interference levels, channels, and/or duty cycles, ignoring errors at certain times while performing rate adaptation, and scheduling high priority packets. In various embodiments, the apparatus can include an access point and can use the LTE-U measurement report for one or more of: selecting an operating channel, adjusting Target Beacon Transmit Time (TBTT) or Delivery Traffic Indication Message (DTIM) timing, scheduling off-channel operation, transmitting one or more frames during an LTE-U idle period, determining a rate adaptation, applying Unscheduled Automatic Power Save Delivery Coexistence (UAPSD) mechanisms, and scheduling channel sounding packets for transmit beam-forming or multi-user MIMO transmissions.

In various embodiments, the medium can further include code that, when executed, can cause the apparatus to receive another LTE-U measurement report. In various embodiments, the medium can further include code that, when executed, can cause the apparatus to aggregate the LTE-U measurement report and the other LTE-U measurement report into an aggregated LTE-U measurement report. In various embodiments, the medium can further include code that, when executed, can cause the apparatus to transmit the aggregated LTE-U measurement report to one or more other WLAN devices.

In various embodiments, transmitting the aggregated LTE-U measurement report can be in response to a solicitation. In various embodiments, transmitting the aggregated LTE-U measurement report can be unsolicited. In various embodiments, transmitting the aggregated LTE-U measurement report can be in a beacon or probe response frame. In various embodiments, transmitting the aggregated LTE-U measurement report may be in an action-frame, a public action frame or any other frame with appropriate vendor specific information elements.

In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE sub-frame boundary, offset with respect to current sub-frame boundary, number of sub-frames after which Clear channel assessment (CCA) Exempt transmission (CET) signaling repeats for uplink and downlink, Channel Usage Beacon Signal (CUBS) identifier, recommended CCA energy detection (ED) level, and list of applicable channels.

In various embodiments, the medium can further include code that, when executed, can cause the apparatus to encode the aggregated LTE-U measurement report in a vendor specific information element (IE). In various embodiments, the LTE-U measurement report can include LTE-U communication characteristics for more than one type of LTE-U network. In various embodiments, the medium can further include code that, when executed, can cause the apparatus to limit propagation of the aggregated LTE-U measurement report via a number of hops indicated in the aggregated LTE-U measurement report.

In various embodiments, the medium can further include code that, when executed, can cause the apparatus to transmit a field indicating LTE-U awareness. In various embodiments, the medium can further include code that, when executed, can cause the apparatus to provide CUBS identifiers obtained from the LTE-U measurement report to one or more Channel Usage Beacon Signal (CUBS) detectors. In various embodiments, the transmitting can include broadcasting. In various embodiments, the transmitting can include transmitting to a particular device.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates a time sequence diagram of exemplary communications between LTE-U and WLAN devices, according to one embodiment.

FIGS. 4A and 4B illustrate time sequence diagrams of exemplary LTE-U transmissions, and offset to the WLAN LTE-U Measurement Report, according to another embodiment.

FIG. 5 illustrates an example WLAN frame including a plurality of LTE-U measurement reports.

FIG. 6 shows a flowchart for an example method of wireless communication that can be employed within the wireless communication system of FIG. 1.

FIG. 7 shows a flowchart for another example method of wireless communication that can be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the embodiments described herein. Details are set forth in the following description for purpose of explanation. In other instances, well-known structures and processes are not elaborated in order not to obscure the description of the disclosed embodiments with unnecessary details. Thus, the present application is not intended to be limited by the implementations shown, but is to be accorded with the broad scope consistent with the principles and features disclosed herein.

A WLAN device as described herein may use the protocols described in any of the 802.11 family of standards, such as 802.11a, 802.11ah, 802.11ac, 802.11n, 802.11g, 802.11b, 802.11ax and others. The WLAN device may be an access points (“APs”), or a station (“STAs”). In general, an AP serves as a hub or a base station for the STAs in the communication network. An STA may be a laptop computer, a personal digital assistant (PDA), a mobile phone, etc. In general, an STA wirelessly connects to an AP via an IEEE 802.11 protocol communication link to have, for example, a wireless connectivity to the Internet, other devices and other networks. An STA may also operate as an AP.

In various embodiments, next-generation user equipment (UE) can include both LTE-U and WLAN radios. In an example first step, discussed herein in the section titled “LTE-U Measurement Capable Devices,” such UEs can access LTE-U specific information from an on-board LTE-U modem, in order to beneficially leverage such information locally. Moreover, in an example second step, discussed herein in the section titled “Contents of LTE-U Measurement Report,” the UEs can share the LTE-U specific information with nearby WLAN nodes. In a third example step, discussed herein in the section titled “LTE-U Aware Devices,” capable WLAN devices (e.g., access points (APs)) can act as an aggregation point for information received from other UEs, and can further locally leverage the information received. LTE-U aware APs can leverage the LTE-U measurement report as discussed in the section titled “Acting on LTE-U Measurement Reports—APs.” Similarly, capable WLAN stations (STAs) can locally leverage the information received as discussed in the section titled “Acting on LTE-U Measurement Reports—STAs.”

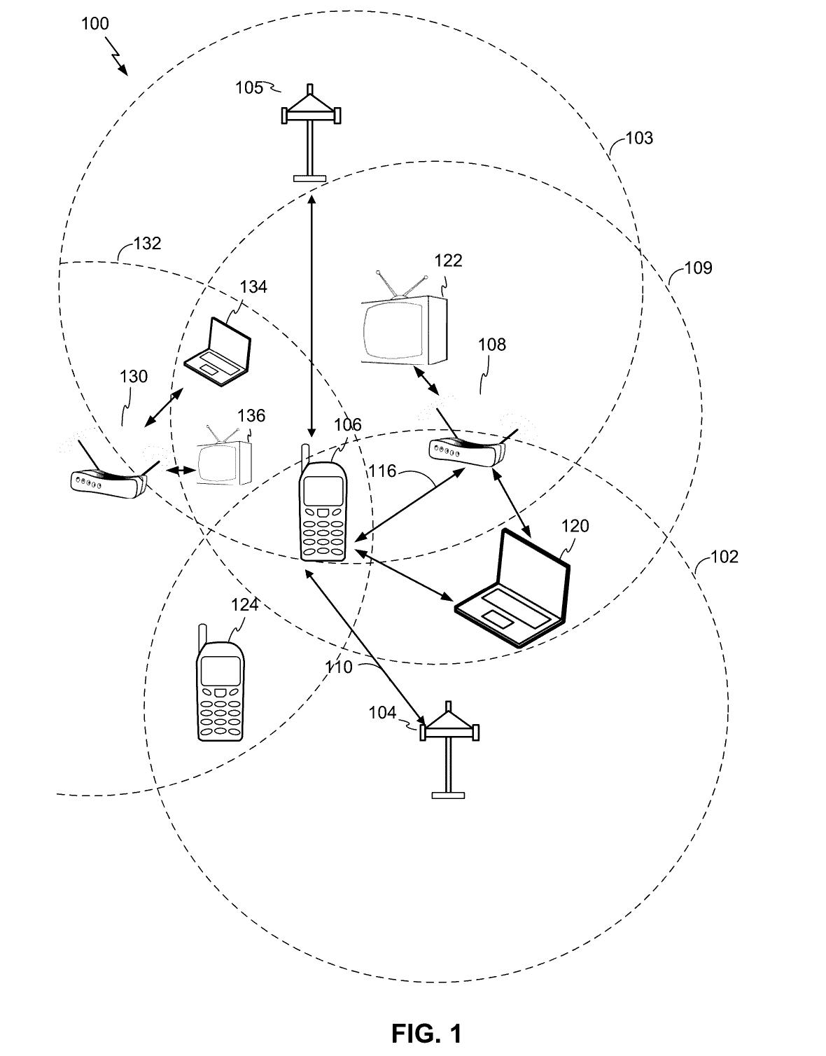

FIG. 1 illustrates an example of a wireless communication system 100 that may be incorporating various aspects of the present disclosure. The illustrated wireless communication system 100 includes base stations (BSs) 104 and 105, user equipment (UE) 106 and 124, APs 108 and 130, and STAs 120, 122, 134, and 136. The BS 104 provides wireless communication coverage in a coverage area 102. The BS 105 provides wireless communication coverage in a coverage area 103. In some embodiments, the operations of BS 104 and 105 may be managed by different operators.

In the illustrated embodiment, AP 108 provides wireless communication coverage in a basic service area (BSA) 109. WLAN STAs 120 and 122 operate within the BSA 109 and are associated and communicating with AP 108. Similarly, AP 130 provides wireless communication coverage in a basic service area (BSA) 132. WLAN STAs 134 and 136 operate within the BSA 109 and are associated and communicating with AP 130. In the illustrated embodiment, the BSA 132 of AP 130 at least partially overlaps with BSA 109 of AP 108.

The wireless communications in coverage area 102 and BSA 109 may include communications in an unlicensed frequency spectrum. A wireless communication connectivity service in accordance with LTE-U standard protocols may be provided by BS 104, providing such a wireless connectivity service includes at least transmission of LTE-U communications (e.g., data packets). In accordance with an embodiment, WLAN communications may also be transmitted by BS 104, for example, for data communications or to protect the LTE-U communications. Therefore, in accordance with an embodiment, a wireless communication link 110 between BS 104 and UE 106 may include transmission and reception of data packets in accordance with LTE-U and WLAN standards protocols. The AP 108 may communicate with UE 106 over a wireless communication link 116 in accordance with WLAN standard protocols in the unlicensed frequency spectrum. As such, wireless communication link 110 and wireless communication link 116 may occur over a common unlicensed frequency spectrum at essentially the same time or overlapping time periods.

UE 124 is capable of LTE and WLAN communications, but is not capable of LTE-U communications. Thus, UE 124 can support LTE communications in licensed bands but not unlicensed frequency bands. UE 124, however, can support WLAN communications in the unlicensed frequency bands. UE 124 can include, for example, capability for communications in accordance with various commonly known standards for cellular telephone communications. Embodiments described herein are particularly related to coexisting operations of LTE-U and WLAN devices using common communication resources (e.g., frequency spectrum and transmission time). Generally, wireless communication system 100 includes many different devices while operating over a common unlicensed frequency spectrum. Some of these devices may be operating in accordance with WLAN standards (WLAN devices) and while others in accordance with the LTE-U standard (LTE-U devices). The LTE-U and WLAN wireless communication links with such devices may occur at essentially the same time or overlapping time periods. Other devices may operate using LTE over licensed spectrum. And some devices can support various combinations of the technologies (for example, any combination of LTE, LTE-U, and WLAN).

Sharing communication resources such as the frequency spectrum and the available transmission times typically create coexistence problems for devices operating in accordance with two different standards (e.g. LTE-U and WLAN). Generally, the WLAN devices may not detect presence of an LTE-U signal, and thus can be unaware of the presence of LTE-U communication while transmitting WLAN signals. Such coexisting operations would cause interference for the LTE-U communications, and may limit access for the LTE-U device to the same frequency spectrum during desired time periods. The LTE-U communications may also be causing interference for the WLAN communications, thereby leading to increased deferrals and/or packet error rates. As a result, the WLAN and the LTE-U devices may experience degradation of communication data throughput as well as collisions of transmitted signals. Various aspects of the disclosure improve the efficiency of using the unlicensed frequency spectrum in wireless communication system 100 where the possibility exists for different transmissions to occur in accordance with WLAN and LTE-U standards. In accordance with various aspects of the disclosure and as described in more detail, wireless communications typically have coexistence problems when different systems operate in proximity of each other and/or overlapping coverage areas by sharing the same communication resources, such as time and frequency resources. The wireless communication signals transmitted by one system may be received at different signal strengths at devices operating with another system. An LTE-U transmitted signal (for example, over wireless communication link 110) may be received at a signal strength level that is below the energy detection level at a WLAN device (such as AP 108). Accordingly, WLAN devices may be unaware of LTE-U communications and may transmit during LTE-U communications which would interfere with the LTE-U communication as well as the LTE-U communication interfering with the WLAN communications. In such scenarios, both the WLAN and the LTE-U devices may experience throughput degradation from interference and collisions between the two communication protocols. It may be desirable for WLAN devices to detect presence of LTE-U devices and LTE-U communications so that the WLAN devices may adjust their operation to improve throughput and communication efficiency of the system. Embodiments described herein relate to coexistence between LTE-U and WLAN devices, however, they may also apply to other RATs and protocols.

In general, BS 104 and/or BS 105 can transmit LTE-U communications implementing carrier sensing adaptive transmission (CSAT) with duty cycles of up to 640 ms on time and 640 ms off time. In some embodiments, for the LTE-U communications, a process commonly referred to as listen before talk (LBT) may not have been utilized, wherein a transmitter could perform clear channel assessment (CCA) prior to initiation of the LTE-U communications. In other embodiments, LTE-U communications can utilize LBT rules. In various embodiments, each LTE-U communication can include one or more notches or silent periods during which no LTE-U communication is transmitted in order to enable other wireless devices to access the channel without interference.

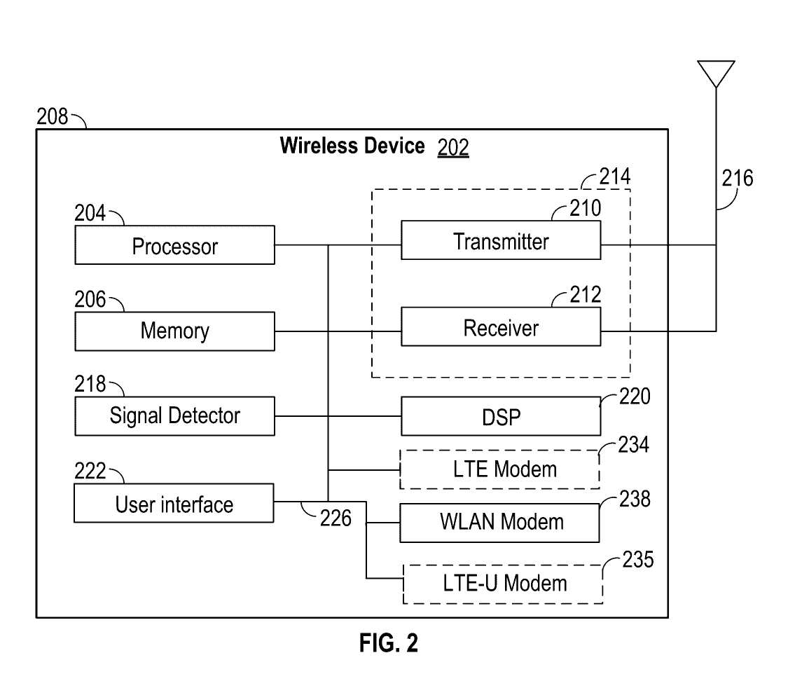

In some embodiments, one or more devices such as the UE 106 may include hardware and/or software (e.g., LTE modem 234, LTE-U modem 235, and WLAN modem 238 shown in FIG. 2) such that it is able to measure LTE-U communication characteristics (for example, timing and frequency characteristics for BS 104 and/or BS 105). UE 106 can be configured to generate an LTE-U measurement report including such measured LTE-U communication characteristics, and can transmit the report to other WLAN devices, for example AP 108, STAs 120 and 122, and UE 124.

Devices capable of either measuring LTE-U communication characteristics (“LTE-U measurement capable devices”, for example, UE 106), or capable of decoding the LTE-U measurement report generated by LTE-U measurement capable devices (“LTE-U aware devices”, for example, AP 108, STA 120 and 122, and UE 124) can use the information contained in the report, such as timing and frequency characteristics, in order to determine transmission timing of WLAN communications in a manner that reduces potential interference in the wireless communication system 100. In various embodiments, WLAN devices can indicate that they are LTE-U aware or LTE-U measurement capable via signaling including one or more capability bits. Such signaling may be performed before, during, or after WLAN association. Such signaling for communicating the capabilities may be exchanged via communications of vendor specific information elements, management, control or data frames, as will be understood by those skilled in the art.

In accordance with various aspects of the disclosure, an LTE-U aware device, such as AP 108, may serve as aggregators of LTE-U measurement reports (“LTE-U measurement report aggregators” or “aggregators”). For example, the AP 108 may receive the LTE-U measurement reports from one or more devices. The AP 108, through a LTE-U measurement report aggregating process, generates an aggregated report and broadcast the aggregated report which is compiled from information received from multiple LTE-U measurement capable devices. Such aggregated reports may be broadcast via beacons or exchanged via vendor specific information elements or data, control, or management frames.

In accordance with an embodiment, the aggregated report is broadcasted and could be received by many devices for example in wireless communication system 100. Such devices may not be associated with AP 108 but yet utilize the aggregated report. Thus, in the example of FIG. 1, STAs 134 and 136 can utilize the broadcasted aggregated LTE-U measurement report sent by AP 108, even though they are not associated to AP 108 when the report is broadcasted. Moreover, STAs 134 and 136 can in turn communicate the information with their associated AP 130. As such, a received aggregated report or certain information contained within the received aggregated report may be communicated/propagated to other devices in wireless communication system 100.

In an embodiment, each device can control the extent of propagation of the LTE-U measurement report and/or broadcasted aggregated LTE-U measurement report by specifying a hop count limit wherein each device forwarding a report increments a hop count and does not forward information that exceeds a hop count limit.

FIG. 2 illustrates various components of a wireless device 202 for operation in wireless communication system 100. In various embodiments, the wireless device 202 is suitable for performing the operations as may be required by the devices described with respect to FIG. 1, including BS 104, AP 108 or UE 106. Although certain components are shown in FIG. 1, a person having ordinary skill in the art will appreciate that components can be added, rearranged, omitted, commonly implemented, or individual components separated into multiple components. The wireless device 202 may be configured and used differently for each such device, depending on the various operations that may be required in wireless communication system 100.

In some embodiments the elements of the LTE-U measurement report or aggregated measurement report may be transmitted by the BSs 105 or 106 themselves (for example using a co-located WLAN module in the BS). Such information may be embedded in a protection signal as described in U.S. Provisional Application No. 61/126,433 (attorney reference QTELE.178PR/150749, filed Feb. 27, 2015) and U.S. Provisional Application No. 61/126,434 (attorney reference QTELE.182PR/151542, filed Feb. 27, 2015), or transmitted as a separate WLAN communication from time to time. In particular, any information in the LTE-U measurement report and aggregated measurement report described herein can be an example of information that can be included in a WLAN protection signal.

In various embodiments, the wireless device can include a WLAN modem 238, an LTE modem 234, and/or an LTE-U modem 235. The WLAN modem 238 is generally utilized to perform functions associated with WLAN communications. The LTE modem 234 is generally utilized to perform functions associated with LTE communications. The LTE-U modem 235 is generally utilized to perform functions associated with LTE-U communications. The devices in wireless communication system 100 have different levels of functionality and capability. Some devices may include LTE modem 234, WLAN modem 238 and LTE-U modem 235. Some devices may have only WLAN modem 238. Depending on the required functionality of the device, one or more of such modems may be implemented.

For example, in some embodiments where the wireless device 202 is configured and used for performing the WLAN operations of the AP 108 or 130, or the STAs 120, 122, 134 or 136, the LTE modem 234 and LTE-U modem 235 may be not operational (turned off) or omitted from the device 202. As another example, in some embodiments where the wireless device 202 is configured and used for performing the operations of UE 124, LTE-U modem 235 can be omitted. As another example, in some embodiments where the wireless device 202 is configured and used for performing the operations of UE 106, each of the LTE modem 234, the LTE-U modem 235, and the WLAN modem 238 can be included, or just the LTE modem 234 can be omitted.

The wireless device 202 may include a processor 204 which may control operation of wireless device 202. Processor 204 may also be referred to as a central processing unit (CPU) or hardware processor. Processor 204 typically performs logical and arithmetic operations based on program instructions stored within a memory 206 which may include both read-only memory (ROM) and random access memory (RAM). A portion of memory 206 may also include non-volatile random access memory (NVRAM). The instructions in memory 206 may be executable to implement various aspects described herein. Processor 204 may include or be a component of a processing system implemented with one or more processors and may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Processor 204 and memory 206 may include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The processor 204 may further include a data packet generator to generate data packets for controlling operation and data communication.

Wireless device 202 may include a transmitter 210 and a receiver 212 to allow wireless transmission and reception of data. Transmitter 210 and receiver 212 may be combined into a transceiver 214. An antenna 216 may be electrically coupled to transceiver 214. Although not shown, wireless device 202 may include multiple transmitters, multiple receivers, and/or multiple antennas. In an embodiment, although not shown, an antenna may be dedicated for each of the LTE-U and WLAN communications, or multiple antennas dynamically shared between multiple radios. Similarly, a receiver and a transmitter may be dedicated to for each of the LTE, LTE-U, and WLAN communications. The operations associated with LTE, LTE-U, and WLAN communications, including the modems 234, 235, and/or 238, may also be performed collectively by the same receiver and transmitter. Wireless device 202 may be enclosed by a housing unit 208.

Wireless device 202 may also include LTE modem 234 for LTE communications and/or LTE-U modem 235 for LTE-U communications. Wireless device 202 may also include a WLAN modem 238 for WLAN communication. LTE modem 234, LTE-U modem 235, and WLAN modem 238 may contain processing capabilities for operations associated with processing at both the physical (PHY) layer and the medium access control (MAC) layer of the corresponding LTE, LTE-U, and WLAN standards. Although LTE modem 234, LTE-U modem 235, and WLAN modem 238 are shown separately, one of ordinary skill in the art may appreciate that the functions performed by these components may be performed by a common component of wireless device 202, or their functions can be linked via hardware and/or software. Moreover, the functions associated with LTE modem 234, LTE-U modem 235, and WLAN modem 238 may also be performed by other components such as processor 204 and a digital signal processor (DSP) 220.

Wireless device 202 may transmit and receive LTE, LTE-U, and/or WLAN communications over antenna 216, transmitter 210, and receiver 212, each of which may be operationally connected to LTE modem 234, LTE-U modem 235, and WLAN modem 238. As disclosed herein, wireless device 202 may not require all the functionalities and components as shown and described when wireless device 202 is being used and implemented in AP 108, BS 104 or UE 106. In accordance with the disclosure, the basic functionality of WLAN modem 238 may be limited to processing transmission of WLAN data packets. For example, wireless communication link 110 between BS 104 and UE 106 may include transmission and reception of LTE-U communication and transmission and reception of WLAN communications. Therefore, in BS 104, the basic functionality of WLAN modem 238 may be limited to processing transmission of WLAN communications.

Wireless device 202 may also include a signal detector 218 to detect and quantify the level of received signals. Signal detector 218 may detect such signals in a form of detecting total energy, energy per subcarrier per symbol, power spectral density and others. Wireless device 202 may also include DSP 220 for use in processing signals. DSP 220 may operationally be connected and share resources with processor 204 and other components.

Wireless device 202 may further include a user interface 222 in some aspects. User interface 222 may include any element such as a keypad, a microphone, a speaker, and/or a display for conveying information to a user of wireless device 202 and/or receives input from the user. Various components of wireless device 202 may be coupled together by a bus system 226 which may include for example a data bus, a power bus, a control signal bus, and a status signal bus.

Although a number of separate components are illustrated in FIG. 2, one of ordinary skill in the relevant art would appreciate that one or more of these components may be implemented not only with respect to the functionality described above, but also to perform the functionality associated with respect to other components. For example, processor 204 may be used to perform not only the functionality described with respect to processor 204, but also the functionality associated with signal detector 218 and/or DSP 220. Each of the components illustrated in FIG. 2 may be implemented using a plurality of separate elements.

In an exemplary embodiment, UE 106 may be configured for communicating in accordance with the operation of LTE-U standard while also configured to communicate in accordance with the WLAN standard. As such, when wireless device 202 is configured to operate as UE 106, WLAN modem 238 can be configured to form and facilitate transmission/reception of such WLAN communications. The WLAN communication can be harmonized with LTE-U communications for improving or ensuring availability of frequency spectrum and timing resources for the LTE-U communications to take place having reduced receive interference from other possible WLAN communications in the unlicensed frequency spectrum. Thus, in various embodiments the wireless communication system 100 can reduce the possibility of experiencing interference at a receiver of the LTE-U communication from transmission of WLAN communication by other WLAN devices. While referring to a configuration of wireless device 202 as UE 106, processor 204 or DSP 220 may operate with LTE-U modem 235 and WLAN modem 238 for generating and transmitting (or receiving) the WLAN communication and the LTE-U communication in accordance with an exemplary embodiment. In accordance with an embodiment, the WLAN communication may also be embedded with information about LTE-U communication.

LTE-U communications can either use contention based channel access techniques or, in certain geographies, non-contention based channel access techniques. In some embodiments, one or more WLAN devices may be unaware of an LTE-U communication schedule. LTE-U measurement capable devices (which may include LTE-U devices themselves and WLAN devices) can determine LTE-U communication characteristics, and can provide such characteristics to LTE-U aware devices via, for example, the LTE-U measurement report. LTE-U aware devices can determine LTE-U communication timing (and other characteristics) from the LTE-U measurement report. Accordingly, interference between WLAN and LTE-U communications can be avoided or substantially reduced.

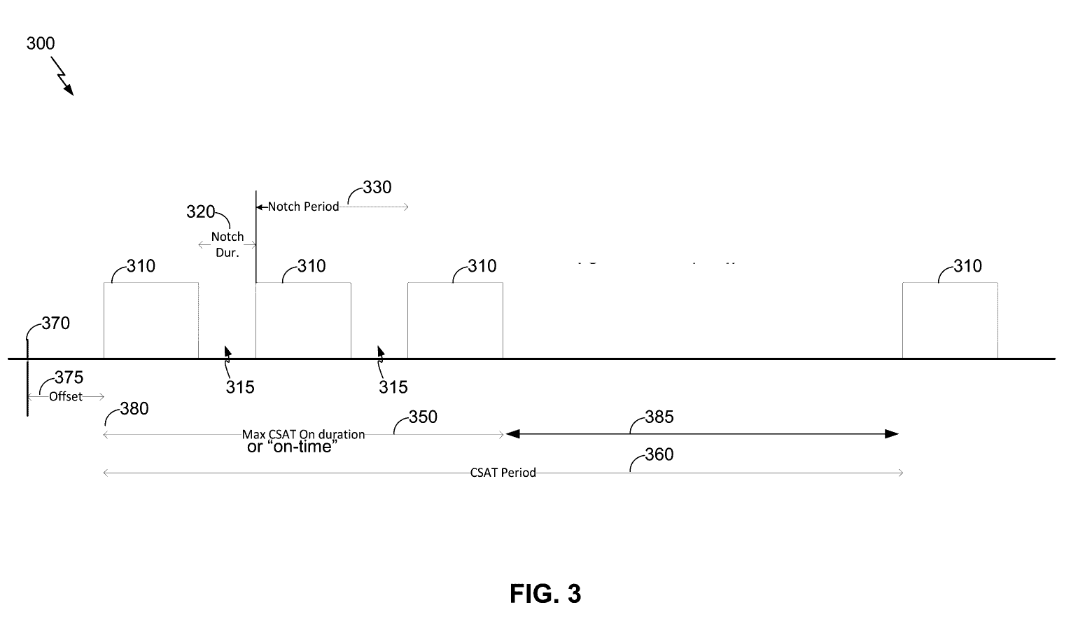

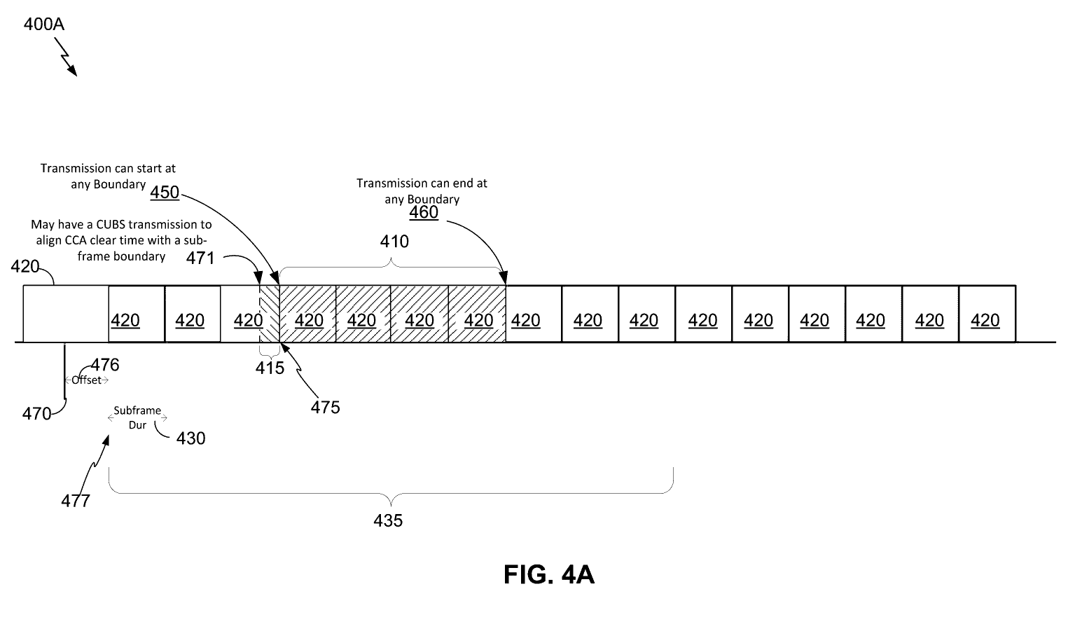

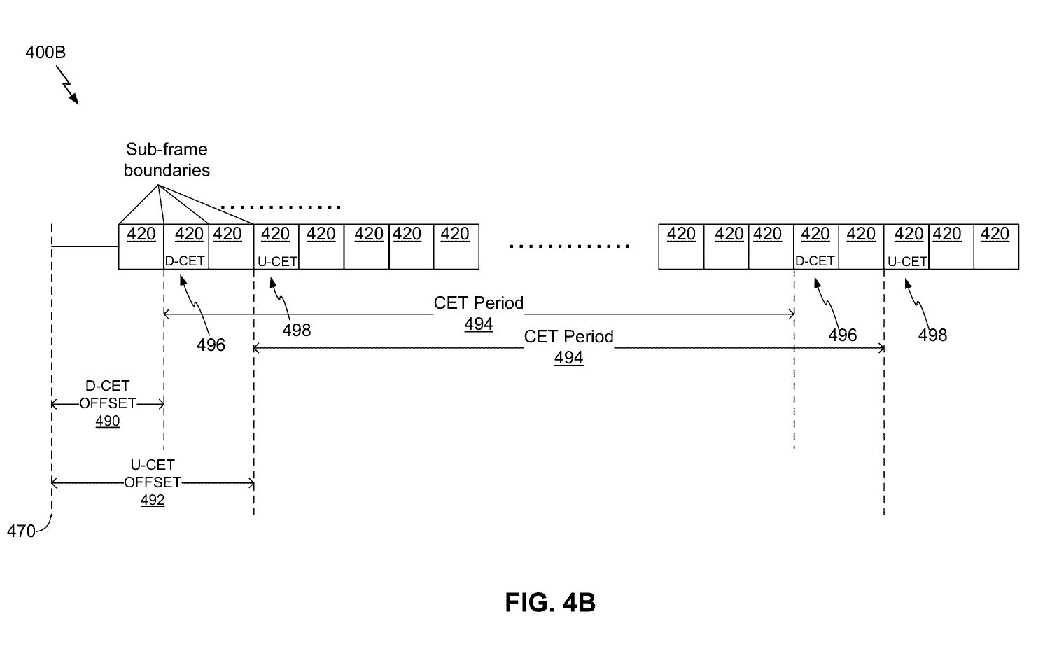

Characteristics describing LTE-U communication timing can be defined according to first and second timing structures, generally discussed with respect to various signal timings as depicted in FIGS. 3 and 4 respectively. For example, LTE-U communication characteristics can include any of the parameters shown in the first and second timing structures of FIGS. 3 and 4, with additional parameters discussed herein and not particularly shown in FIGS. 3 and 4. Although FIGS. 3 and 4 illustrate two exemplary LTE-U communication timing structures, other signal timings are possible. The first timing structure, in which listen before talk (LBT) is not employed, is shown in FIG. 3.

### First Timing Structure

FIG. 3 illustrates a time sequence diagram 300 of exemplary communications between LTE-U devices that are operating without using a listen-before talk (non-LBT) based medium access controller (MAC) mechanism, according to one embodiment. LTE-U communication characteristics defined with respect to the illustrated time sequence diagram 300 can be communicated, for example through the LTE-U measurement report. This embodiment illustrates an exemplary communication exchange within wireless communication system 100 of FIG. 1. Although FIG. 3 is described with respect to non-LBT LTE-U communications, the teachings herein are applicable to coexistence between other sets of wireless communications technologies. Although various communications are shown, additional communications can be added, any communication shown can be omitted, and the timing or order of communications rearranged.

In the illustrated embodiment of FIG. 3, BS 104 transmits LTE-U communications 310 according to various LTE-U timing characteristics. Such LTE-U timing characteristics include, for example, a notch duration 320, a notch period 330, a maximum carrier sensing and adaptive transmission (CSAT) on-time 350, and a CSAT period 360.

As shown in FIG. 3, a carrier sensing and adaptive transmission (CSAT) period 360 can be divided into an on-time and an off-time 385. The on-time may be limited to a maximum on-time 350 (as shown in figure). In practice, actual length of the on-time can be less than 350 and a function of traffic load or other parameters—for example, a number of overlapping WLAN networks detected in the vicinity. In particular, the off-time 385 can be defined as the CSAT period 360, minus the on-time. During the on-time, the BS 104 transmits LTE-U communications 310, which can include data interspersed with notches 315. The notches 315 can have a length according to a notch duration 320, and can be repeated periodically according to a notch period 330. Based on the embodiments above, the off-time 385 can always be idle. In various embodiments, an LTE-U aware device can infer that each notch 315 is always idle, and that rest of the on-time may or may not be idle based on load.

In some embodiments, an LTE-U aware device can transmit an LTE-U measurement report at a time 370, which can be identified by an offset 375 amount of time prior to a start time 380 of the next CSAT period 360. Although exemplary LTE-U timing characteristics are illustrated, a person having ordinary skill in the art will appreciate that one or more illustrated LTE-U timing characteristics can be omitted, or additional LTE-U timing characteristics employed.

In the illustrated embodiment of FIG. 3, each start 380 of the LTE-U CSAT Period 360 has a fixed start time, and a variable on-time (for example, a function of load, etc.), limited to a maximum on-time 350. In other words the number of active LTE-U communications 310, during on-time in each CSAT period 360, may be reduced or increased. Accordingly, idle times (e.g., the notch duration 320 or time between the maximum CSAT on-time 350 and the start of the next CSAT period 360) can be predicted with certainty. Thus, the structure of FIG. 3 can include “assured idle periods.” On the other hand, busy times (e.g., channel occupancy during transmission of the LTE-U communications 310) can be determined as a long-term average

As shown in FIG. 3, the notch duration 320 can be an instance of a scheduled idle time between LTE-U communications 310. Accordingly, one or more WLAN devices can transmit/receive during the notch duration 320 without LTE-U interference. Notch duration 320 can be scheduled to occur at least once every notch period 330. Depending on traffic load, LTE-U communications 310 can be transmitted for up to the maximum CSAT on-time 350. The maximum CSAT on-time 350 can be repeated at least once every CSAT period 360. The time 385 between the end of the maximum CSAT on-time 350 and the beginning of the next CSAT period 360 can be idle. Accordingly, one or more WLAN devices can transmit during idle periods without LTE-U interference.

As discussed, characteristics describing LTE-U communication timing can be defined according to first and second timing structures. In the second timing structure, LTE-U communications can employ a LBT mechanism in contrast to the non-LBT approach of the first timing structure shown in FIG. 3. The second timing structure, in which LBT is employed, is shown in FIGS. 4A and 4B, with FIG. 4B showing an extended time range.

### Second Timing Structure

FIGS. 4A and 4B illustrate time sequence diagrams 400A and 400B of exemplary communications between LTE-U devices, according to one embodiment. This embodiment illustrates an exemplary communication exchange within wireless communication system 100 of FIG. 1. Although FIGS. 4A and 4B are described with respect to LTE-U communications, the teachings herein are applicable to coexistence between other sets of wireless communications technologies. Although various communications are shown, additional communications can be added, any communication shown can be omitted, and the timing or order of communications rearranged.

In the illustrated embodiment of FIG. 4A, BS 104 transmits LTE-U communication 410 according to an LBT MAC mechanism. The LTE-U waveform may have several timing characteristics. Although exemplary LTE-U timing characteristics are illustrated, a person having ordinary skill in the art will appreciate that one or more illustrated LTE-U timing characteristics can be omitted, or additional LTE-U timing characteristics employed.

In the illustrated embodiment of FIG. 4A, timing of start of transmission for LTE-U communication 410 is based on LBT clear channel assessment (LBT-CCA) clearing and traffic load. LTE-U communications can occur during a plurality of sub-frames 420 each having sub-frame boundaries (e.g., boundaries 450 and 460) and sub-frame duration 430, within a radio frame 435. Communications can start at any sub-frame boundary (for example, boundary 450) and can end at any sub-frame boundary (for example, boundary 460). In various embodiments, on-time is variable (for example, a function of load, etc.).

Further, depending on channel activity, LBT or CCA may clear at an instant in time 471 that is not aligned to a sub-frame boundary (e.g., boundaries 450 and 460). The BS 104 may accordingly transmit a channel utilization beacon signal (CUBS) waveform 415 to capture the channel and align the data transmission for LTE-U communication 410 with the next sub-frame boundary 475. As a result, when using the LBT based channel activity mechanism, LTE-U communication activity on the channel cannot be predicted with certainty. However certain aspects, such as a long-term average can be determined.

In some embodiments, the structure of FIG. 4A can also include “assured busy periods” such as, for example, a CCA exempt transmissions (CET). In some embodiments, an LTE-U aware device can transmit an LTE-U measurement report at a time 470, which can be identified by an offset 476 amount of time prior to a start time 477 of the next LTE-U sub-frame boundary 477. In various embodiments, because radio-frames are an integer number of sub-frames 420, the offset 476 can be defined with respect to a start time 477 of the next radio-frame 435.

In the illustrated embodiment of FIG. 4B, several additional timing characteristics are shown. Although exemplary LTE-U timing characteristics are illustrated, a person having ordinary skill in the art will appreciate that one or more illustrated LTE-U timing characteristics can be omitted, or additional LTE-U timing characteristics employed. As shown in FIG. 4B, an LTE-U aware device can identify a Downlink-CET (D-CET) offset 490 as an amount of time between the LTE-U measurement report transmission time 470 and the next D-CET sub-frame 496. Similarly, the LTE-U aware device can identify an Uplink-CET (U-CET) offset 492 as an amount of time between the LTE-U measurement report transmission time 470 and the next U-CET sub-frame 498. It would be apparent to one skilled in the art there may be multiple ways of communicating the CET timing—for example—the position of the U-CET could be represented as relative to the D-CET instead of with respect to the LTE Measurement Report 470. It is understood that these and various alternate methods of representations are covered by the scope of the invention. The D-CET sub-frames 496 can be transmitted periodically, according to a CET period 494 (which can be, for example, 80 ms). Similarly, the U-CET sub-frames 498 can be transmitted periodically, according to the CET period 494. In various embodiments, the LTE-U aware device can identify the CET period 494 as a number of sub-frames 420 after which CET signaling repeats.

### Contents of LTE-U Measurement Report

Any LTE-U measurement capable WLAN device can generate an LTE-U measurement report to convey one or more LTE-U communication characteristics to other LTE-U aware WLAN devices. For example, referring back to FIG. 1, UE 106 can generate an LTE-U measurement report based on LTE-U measurements. Additionally, LTE-U measurement aware devices can forward LTE-U measurement reports received from other devices. UE 106 can transmit the LTE-U measurement report to, for example, AP 108 (in embodiments where AP 108 is LTE-aware). Accordingly, AP 108 can configure its WLAN transmissions in order to avoid LTE-U interference.

Additionally AP 108 can aggregate LTE-U measurement reports received from other devices and in turn forward this aggregated report to other LTE-U aware devices. For example, AP 108 can transmit an aggregated LTE-U measurement report to any of STAs 120 and 122, or to nearby AP 130 via its client STAs 134 and 136. The STAs 134 and 136 are able to receive the transmissions from AP 108 as direct or broadcast transmissions. Other nearby APs, such as AP 130, may also obtain the LTE-U measurement report from its STAs (e.g., 134 or 136) as they include this information in a neighbor report based on scans of nearby WLAN networks requested by AP 130.

The LTE-U measurement report can include one or more of the characteristics shown in Table 1, below.

TABLE 1

| Information Sub-elements | Description |
|---|---|
| Common Content | |
| Network Name/ID, eNB identifier/cellID | Network identifier helps (i) AP to abstract |
| | observations of same eNB/eNBs of same |
| | network; (ii) facilitate WLAN enabled |
| | network search (e.g., for standalone |
| | networks) |
| Regulatory Domain | For example, in regulatory regions such as |
| | Japan where there are no CCA Exempt |
| | Transmissions (CET) |
| Occupied Channel Info | List of channels occupied by LTE-U eNB |
| | Actual channel numbers may be referenced |
| | to the current WLAN regulatory domain |
| Measured power-level | Power-level of eNB (as seen by the UE) |
| Average LTE-U Occupancy (time average) | Determine the average proportion of time |
| | the channel is busy |
| Network Type | For example: LTE-U/LAA/other extensions |
| | of LTE to unlicensed spectrum |
| Directly Visible OR # of hops | Can be used to limit propagation of the |
| | LTE-U Measurement Report to a |
| | predetermined hop count |
| INFORMATION SPECIFIC TO LTE-U | |
| (for example, according to the First | |
| Timing Structure discussed with respect | |
| to FIG. 3) | |
| Offset to next CSAT period start (in us) | Offset to the start of the next CSAT period, |
| | which can be re-computed for every |
| | measurement report that is sent/received (for |
| | example, see offset 375 of FIG. 3) |
| CSAT Max On-Time (in us) | The maximum on-time during the CSAT |
| | cycle (for example, see maximum on-time |
| | 350 of FIG. 3) |
| CSAT Period (in us) | The periodicity of the CSAT cycle (for |
| | example, see CSAT period 360 of FIG. 3) |
| Notch Duration (in us) | The duration of each notch in the CSAT |
| | cycle (for example, see notch duration 320 |
| | of FIG. 3) |
| Notch Period (in us) | The periodicity of the notches in the CSAT |
| | cycle (for example, see notch period 330 of |
| | FIG. 3) |
| INFORMATION SPECIFIC TO LTE-U | |
| (for example, according to the Second | |
| Timing Structure discussed with respect | |
| to FIG. 4A and 4B) | |
| Offset to LTE sub-frame boundary (in us) | Since the LTE-frame is a floating frame, |
| | there is no advance info on which sub-frame |
| | data may start and where it may end - this |
| | information can also provide a timing |
| | reference to a CUBS detector built on a |
| | WLAN device (for example, see offset 476 |
| | of FIG. 4A) |
| D-CET Offset (in us OR sub-frames) | Offset to the Downlink-CET. WLAN UE |
| | can be aware of a 1 ms interference at this |
| | time (for example, see D-CET offset 490 of |
| | FIG. 4B) |
| U-CET Offset (in us OR sub-frames) | Offset to the Uplink-CET. WLAN UE can |
| | be aware of a 1 ms interference at this time |
| | (for example, see U-CET offset 492 of FIG. |
| | 4B) |
| CET Period (in us OR sub-frames) | Number of sub-frames after which the CET |
| | signaling repeats - in other words the |
| | periodicity of the CET (for example, see |
| | CET period 494 of FIG. 4B) |
| CUBS ID | For example, <cellID, PLMNID, . . .>. This |
| | information can be used as an input to a |
| | CUBS detector on a WLAN device. A |
| | WLAN device may include multiple CUBS |
| | detectors for detecting multiple adjacent |
| | LTE-U networks. |

In an embodiment, the LTE-U measurement report includes a network name, ID, BS identifier, eNB identifier, or cell ID. The network identifier can allow AP 108 to abstract observations of BSs of the same network and to facilitate WLAN enabled network search (for example, for standalone networks).

In an embodiment, the LTE-U measurement report includes a regulatory domain such as, for example, an indication of geographical location or national wireless regulatory regime. In an embodiment, the LTE-U measurement report includes occupied channel information. For example, occupied channel information can include a list of channels occupied by BS 104. In an embodiment, actual channel numbers can be referenced to the current WLAN regulatory domain.

In an embodiment, the LTE-U measurement report includes a measured power level. For example, the measured power level can include a power-level of BS 104 (as seen by the device making the measurement).

Accordingly to an embodiment, AP 108 can leverage the measured power-level to determine a CCA energy detection (ED) threshold and limit propagation of LTE-U specific information to its (unassociated) neighbor WLAN devices.

In an embodiment, the LTE-U measurement report includes an average LTE-U channel occupancy. For example, UE 106 can determine the average proportion of time the channel is busy and report the time average. In an embodiment, the LTE-U measurement report includes a network type. For example, network type can include an indication of whether the network of BS 104 implements the first timing structure shown in FIG. 3 or the second timing structure shown in FIGS. 4A and 4B. Thus, where the UE 106 is associated with BS 104, the UE 106 can still measure both BS 104 and BS 105 in order to convey such measurements to WLAN devices such as STAs 120 and 122.

In an embodiment, the LTE-U measurement report includes a number of hops. For example, zero hops can indicate that characteristics included in the LTE-U measurement report are directly measured (for example, by the device generating the LTE-U measurement report). Otherwise, the number of hops can indicate how many times the characteristics included in the LTE-U measurement report have been repeated in a number of hops. In some embodiments, propagation of LTE-U measurement reports can be limited. This may be specified by a hop-count limit in the LTE-U measurement report or by means of a pre-configured policy. An example may be a policy limit of a maximum of 2 hops.

Referring back to FIG. 3, where the network type indicates the first timing structure, the LTE-U measurement report can include the offset 375 from a time 370 of LTE-U measurement report transmission to the next CSAT period 360 start (for example, in μs). The offset 375 specifies the time from transmission time 370 of the LTE-U measurement report to the start time 380 of the next CSAT period 360. In one embodiment, offset durations may be referenced with respect to the local WLAN time synchronization function (TSF) timer present in the UE generating the LTE-U measurement report. In various embodiments, the offset 375 may be communicated as a difference with respect to the time 470 of LTE-U measurement report transmission (according to a TSF timer) or in conjunction with an absolute value of the BSS timer itself.

The LTE-U measurement report can additionally specify the CSAT maximum on-time 350 (for example, in μs), which is a transmission parameter indicating the maximum possible portion of the CSAT period 360 during which transmission will occur. The LTE-U measurement report can further specify the CSAT period 360 (for example, in μs). The parameter for CSAT maximum on-time 350, together with the CSAT period 360 parameter, specifies the duty-cycle of the CSAT waveform. The LTE-U measurement report may also specify the notch duration 320 (for example, in μs), and notch period 330 (for example, in μs).

Referring to FIGS. 4A and 4B, where the network type indicates the second timing structure, the LTE-U measurement report can include one or more of: offset 476 from a time 470 of LTE-U measurement report transmission to the next radio frame 435 or sub-frame 420, D-CET offset 490 (offset with respect to current sub-frame boundary, for example in μs or number of sub-frames), U-CET offset 492 (offset with respect to D-CET or sub-frame boundary, for example in μs or number of sub-frames), CET period 494 (duration after which the CET signaling repeats, for example in μs or number of sub-frames), and CUBS ID (information that can serve as input to a CUBS detector, for example cell ID and/or public land mobile network ID), or a MAC address or some other unique address. It would be apparent to one skilled in the art that the D-CET and U-CET may have different periods, in which case the LTE-U Measurement Report may contain separate periods for both these quantities. Because the LTE-frame is a floating frame in embodiments having the second timing structure, there is no advance information on when a transmission of data may start (e.g., 450) and when it may end (e.g., 460). Accordingly, the offset information can provide timing reference to a CUBS detector (for example, CUBS can appear on the last OFDM symbol of every sub-frame 420).

In some embodiments, the LTE-U measurement report can include a recommended CCA energy detection (ED) level (for example, drawn within the range from −50 dBm to −92 dBm). In some embodiments, the LTE-U measurement report can include a list of occupied channels. The list of occupied channels can include, for example, a list of secondary channels on which BS 104 is making the CCA-ED recommendation.

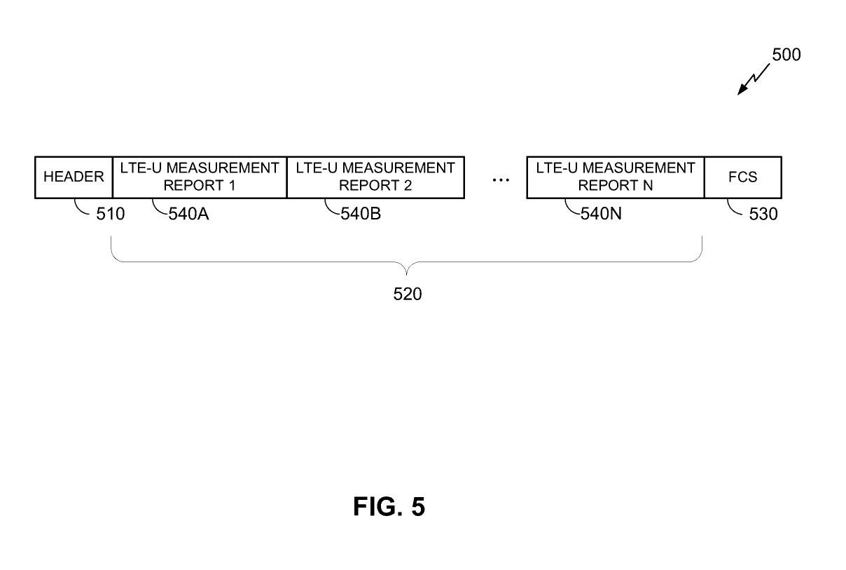

In various embodiments, one or more LTE-U measurement reports can be transmitted in the payload of a WLAN frame. The WLAN frame can be, for example, an 802.11 frame. One such frame is shown in FIG. 5.

FIG. 5 illustrates an example WLAN frame 500 including a plurality of LTE-U measurement reports 540A-540N. In the illustrated embodiment, the WLAN frame 500 includes a WLAN header 510, a payload 520, and a frame check sequence (FCS) or cyclic redundancy check (CRC) 530. In various embodiments, the WLAN frame 500 can omit one or more fields shown in FIG. 5 and/or include one or more fields not shown in FIG. 5, including any of the fields discussed herein. For example, while the payload 520 is illustrated including a plurality of LTE-U measurement reports 540A-540N, in some embodiments there can be just a single LTE-U measurement report 540A. In some embodiments, where multiple LTE-U measurement reports are included, the combined reports can be referred to as an aggregated LTE-U measurement report. A person having ordinary skill in the art will appreciate that the fields in the WLAN frame 500 can be of different suitable lengths, and can be in a different order. In an embodiment, the frame 500 may be transmitted as a WLAN Action Frame or a Public Action frame with the LTE-U measurement report or Aggregate LTE-U measurement reports embedded as vendor specific IEs. As per another embodiment, this information may be transmitted in a beacon or a probe response or any other WLAN frame within a vendor specific information element.

### LTE-U Measurement Capable Devices

Referring back to FIG. 1, one or more devices can be capable of performing LTE-U measurements and providing LTE-U measurement reports to LTE-U aware devices (which can include APs and STAs). For example, UE 106 can scan LTE-U communications and generate the LTE-U measurement report. UE 106 can transmit the LTE-U measurement report to AP 108 (for example, unsolicited, or in response to a request from AP 108). LTE-U measurement capable devices can use the information it measures, or receives from a report from another LTE-U aware device, to alter its behavior. In various embodiments, the LTE-U measurement capable devices can take any action described with respect to LTE-U measurement aware devices. For example, if the LTE-U measurement capable device is a UE (such as UE 106 of FIG. 1), it can use the same information included in the LTE-U measurement report to take any action described in the section titled “Acting on LTE-U Measurement Reports—STAs.” If the LTE-U measurement capable device is a AP (such as AP 108), it can use the information included in the LTE-U measurement report to take any action described in the section titled “Acting on LTE-U Measurement Reports—APs.”

As discussed herein, LTE-U measurement reports can be provided by LTE-U measurement capable devices in a solicited or unsolicited manner. For example, LTE-U measurement capable devices can transmit LTE-U measurement reports at regular intervals or when changes above a configured threshold are detected. In some embodiments, LTE-U aware devices can solicit LTE-U measurement reports. For example, AP 108 can subscribe to UE 106 to provide LTE-U measurement reports when updated information is available. The sections titled “Acting on LTE-U Measurement Reports—STAs” and “Acting on LTE-U Measurement Reports—APs” further describe actions that can be taken based upon information in the LTE-U measurement reports.

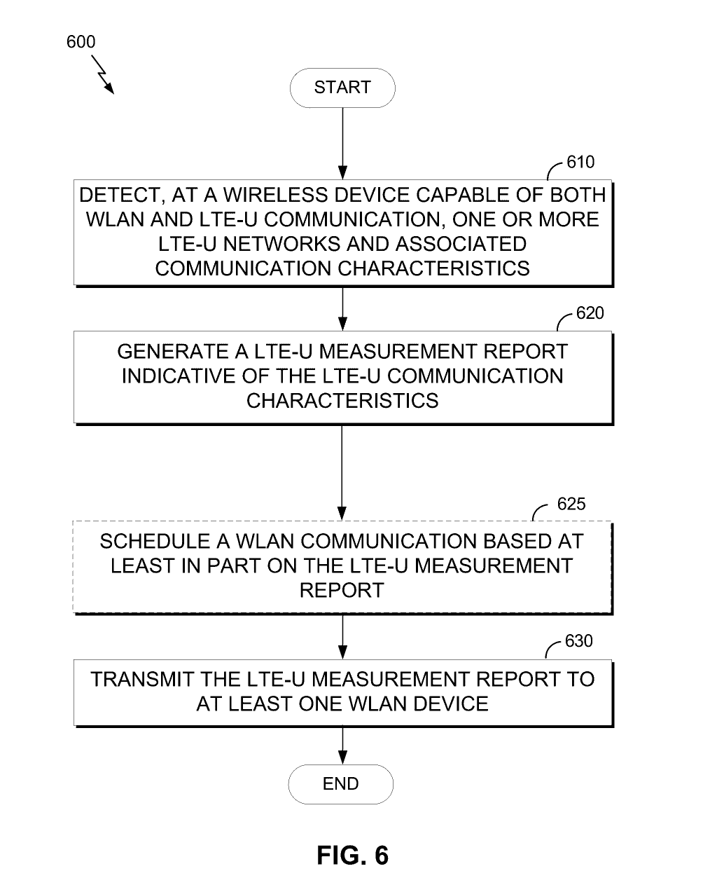

FIG. 6 shows a flowchart 600 for an example method of wireless communication that can be employed within wireless communication system 100 of FIG. 1. The method can be implemented in whole or in part by the devices described herein, such as wireless device 202 shown in FIG. 2. Although the illustrated method is described herein with reference to wireless communication system 100 discussed above with respect to FIG. 1 and communications 300-400 discussed above with respect to FIGS. 3-4, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 610, a wireless device capable of both WLAN and LTE-U communication (e.g., at minimum a “LTE-U Measurement Capable” device) detects one or more LTE-U networks and its associated communication characteristics. For example, UE 106 can detect any of the LTE-U communication characteristics discussed above with respect to FIGS. 3-4. In various embodiments, LTE-U communication characteristics can include any combination of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time, CSAT period, notch duration, notch period, offset to LTE-U sub-frame boundary, number of sub-frames after which CCA exempt transmission (CET) signaling repeats, Channel Usage Beacon Signal (CUBS) identifier, recommended CCA-ED level, and list of applicable channels.

Although the method of flowchart 600 is described herein as being performed by the UE 106, any LTE-U measurement capable device can perform the method of flowchart 600.

Next, at block 620, the wireless device generates a LTE-U measurement report indicative of the LTE-U communication characteristics. For example, UE 106 can generate the LTE-U measurement report to include any of the LTE-U communication characteristics discussed herein and in relation with the section titled “LTE-U measurement report.” In some embodiments, the LTE-U measurement report can include an offset of the time of the LTE-U measurement report (for example, either of time 370 of FIG. 3 or time 470 of FIG. 4A) with respect to the LTE-U radio-frame boundary e.g., the boundary of 435, or a sub-frame boundary—for example, any of boundaries 450 or 460 of FIG. 4A). In some embodiments, the LTE-U measurement report can include an absolute time-stamp or time synchronization function (TSF) of the BSS of which the reporting device is part of, and at which the LTE-U frame is expected to start.

Then, at block 625, the wireless device optionally schedules a WLAN communication based at least in part on the LTE-U measurement report. For example, the UE 106 can make channel selection decisions, request off-channel operation schedules, transmitting one or more frames during an LTE-U idle period, determine a rate adaptation, and apply UAPSD mechanisms.

Then, at block 630, the wireless device transmits the LTE-U measurement report to at least one WLAN device. In other embodiments the wireless device may broadcast the LTE-U measurement report. For example, UE 106 can transmit the LTE-U measurement report to AP 108, or to another STA in wireless communication system 100. The AP 108 and UE 106 can take one or more actions (discussed herein in the sections titled “Acting on LTE-U Measurement Reports—APs” and “Acting on LTE-U Measurement Reports—STAs”) based on the contents of the LTE-U measurement report and/or measured LTE-U communication characteristics.

In various embodiments, the wireless device can further receive one or more LTE-U measurement reports, either from other LTE-U measurement capable devices, or from LTE-U aware devices, relaying single or aggregated LTE-U measurement reports. The wireless device can receive the LTE-U measurement reports at different times and from the same or a different previously reporting device. In various embodiments, the wireless device can aggregate multiple LTE-U measurement reports into an aggregated LTE-U measurement report. In various embodiments, the wireless device can transmit the aggregated LTE-U measurement report to one or more other LTE-U aware devices.

In various embodiments, the method can further include transmitting the LTE-U measurement report in response to a solicitation or a request from a device. In various embodiments, the method can further include transmitting the LTE-U measurement report unsolicited. In various embodiments, the method can further include transmitting the LTE-U measurement report in a beacon or probe response. In various embodiments, transmitting the LTE-U measurement report may be in an action-frame, a public action frame or any other frame with appropriate vendor specific information elements. The LTE-U measurement report may also be transmitted periodically based on a timing schedule.

In various embodiments, the LTE-U measurement report includes one or more of: a network name, network identifier, cell identifier, regulatory domain, list of occupied channels, measured power level, average LTE-U occupancy, network type, number of hops, offset to the next carrier sensing adaptive transmission (CSAT) cycle start, CSAT maximum on-time parameter, CSAT period, notch duration, notch period, offset to LTE-U sub-frame boundary, offset with respect to current sub-frame boundary, number of sub-frames after which Carrier Ethernet Transport (CET) signaling repeats, Channel Usage Beacon Signal (CUBS) identifier, recommended CCA-ED level, and list of applicable channels. Various exemplary parameters are shown and described above with respect to Table 1.

In various embodiments, the method can further include encoding the LTE-U measurement report in a vendor specific information element (IE). In various embodiments, the LTE-U measurement report can include LTE-U communication characteristics for more than one type of LTE-U network. In various embodiments the LTE-U measurement report may be transmitted unsolicited, for example as a WLAN public action frame. In various embodiments, the LTE-U measurement report may be transmitted as a WLAN action frame. In various embodiments, the LTE-U measurement report may be transmitted via WLAN data, management, or control frames.

In various embodiments, the method can further include limiting propagation of the LTE-U measurement report via a number of hops indicated in the LTE-U measurement report.

In various embodiments, the method can further include transmitting one or more capability indications including one or more of: a field indicating LTE-U awareness, and a field indicating LTE-U measurement capability. In various embodiments, the wireless device can facilitate detection of the LTE-U Channel Usage Beacon Signal using an appropriate detector with the information contained in the CCA exempt transmissions (CET) signaling as contained in the LTE-U measurement report.

In various embodiments, the transmitting can include broadcasting. For example, the device 202 can broadcast the LTE-U measurement report. In various embodiments, the transmitting can include transmitting to a particular device.

In an embodiment, the method shown in FIG. 6 can be implemented in a wireless device that can include a detecting circuit, a generating circuit, and a transmitting circuit. Those skilled in the art will appreciate that a wireless device can have more components than the simplified wireless device described herein. The wireless device described herein includes only those components useful for describing some prominent features of implementations within the scope of the claims.

The detecting circuit can be configured to detect the LTE-U communication characteristics. In some embodiments, the detecting circuit can be configured to perform at least block 610 of FIG. 6. The detecting circuit can include one or more of processor 204 (FIG. 2), memory 206 (FIG. 2), and DSP 220 (FIG. 2). In some implementations, means for detecting can include the detecting circuit.

The generating circuit can be configured to generate the LTE-U measurement report. In some embodiments, the generating circuit can be configured to perform at least block 620 of FIG. 6. The generating circuit can include one or more of processor 204 (FIG. 2), memory 206 (FIG. 2), and DSP 220 (FIG. 2). In some implementations, means for generating can include the generating circuit.

The transmitting circuit can be configured to transmit the LTE-U measurement report. In some embodiments, the transmitting circuit can be configured to perform at least block 630 of FIG. 6. The transmitting circuit can include one or more of WLAN modem 238, transmitter 210 (FIG. 2), antenna 216 (FIG. 2), and transceiver 214 (FIG. 2). In some implementations, means for transmitting can include the transmitting circuit.

### LTE-U Aware Devices

Referring back to FIG. 1, one or more devices can be capable of receiving one or more LTE-U measurement reports, aggregating the reports, and providing aggregated LTE-U measurement reports to other devices. Such LTE-U aware devices can include both APs and STAs, and LTE-U measurement capable devices can support any functionality discussed herein with respect to LTE-U aware devices. In one example, LTE-U aware AP 108 may receive LTE-U measurement reports from other LTE-U measurement capable or LTE-U aware devices and generate a consolidated LTE-U measurement report, which it can aggregate with the LTE-U measurement report received from, for example UE 106, UE 124, STA 120, etc.

When the LTE-U aware device is an AP, the AP can further advertise the LTE-U measurement reports. For example, upon aggregating LTE-U measurement reports (or receiving a single report), AP 108 can advertise the information in the LTE-U measurement reports, for example via beacons, probe responses, and so on. When the LTE-U aware device is a STA, the STA can forward the information in the LTE-U measurement reports to other LTE-U aware devices, which can be outside the range of the device from which the LTE-U measurement report was received. For example, upon aggregating LTE-U measurement reports (or receiving a single report), STA 136 can relay the information in the LTE-U measurement reports, for example to AP 130. In various embodiments, the LTE-U measurement reports can be signaled in a vendor specific Information Element (IE) or another standards compliant manner (for example, another IE).

In addition to aggregating and forwarding LTE-U measurement reports, LTE-U aware devices can also internally act on LTE-U measurement reports as discussed in the sections titled “Acting on LTE-U Measurement Reports—STAs” and “Acting on LTE-U Measurement Reports—APs.”

Based on the embodiments herein, it would be apparent to a person having ordinary skill in the art that an LTE-U Measurement Capable device can also be a LTE-U Measurement Aware device.

### Acting on LTE-U Measurement Reports—APs

In various embodiments where the device is an access point the device can use the information in the LTE-U Measurement Report to perform channel selection, adjust Target Beacon Transmit Time (TBTT) and/or Delivery Traffic Indication Message (DTIM) timing, advertise a Notice of Absence (NoA) in order to schedule off-channel operation, transmit high priority frames (for example, beacons, control frames, or management frames) during known idle periods, determine Modulation and Coding Scheme (MCS) and rate adaptation when aware of a concurrent an LTE-U communication, and/or apply Unscheduled Automatic Power Save Delivery (UAPSD) mechanisms to avoid transmissions to STAs experiencing LTE-U interference.

For example, AP 108 can readjust its local target beacon transmission time (TBTT) and delivery traffic indication map (DTIM) timing to avoid LTE-U active transmission time of either co-located or nearby LTE-U cell. Similarly, AP 108 can readjust DTIM/beacon timing to occur during an ‘assured’ idle period of the LTE-U transmission—for example during the CSAT off duration to prevent beacon collisions with LTE-U or a waking up STA from having to wait for the channel to become clear (after an LTE-U transmission). In context of the first timing structure (for example, see section titled “First Timing Structure” and FIG. 3), AP 108 can choose a beacon period that avoids the CSAT-on time altogether.

In various embodiments, AP 108 can declare AP-sleep, for example during CSAT period/LTE-cycle. In various embodiments, AP 108 can send a CTS-to-self to prevent other WLAN devices from actively transmitting during this time. In various embodiments, WLAN devices can perform internal RF calibration during this time.

In various embodiments, AP 108 can use off-channel operation during a LTE-U communication event, for example from either a co-located small-cell (SC) or a nearby SC (as learned from LTE-U Measurement Reports) In various embodiments, such off-channel operation can allow for APs and clients to go off-channel during an LTE-U communication (such as a CSAT event as shown in FIG. 3).

In various embodiments, a serving AP 108 can receive UAPSD signaling from its associated STAs—e.g., 106 to learn of an LTE-U eNB (for example, BS 104) that it is aware of, or is being served by, so that the AP 108 can avoid transmitting to the UE 106 during the period when the UE is receiving LTE-U.

### Acting on LTE-U Measurement Reports—STAs

Upon receiving LTE-U measurement reports, LTE-U aware STAs (such as the STA 120) can determine LTE-U interference levels, channels, and/or duty cycles. LTE-U aware STAs can use the LTE-U measurement report to make channel selection decisions, for example by requesting that the AP switch operating channels (e.g., according to 802.11k/v mechanisms). Similarly, LTE-U aware STAs can determine channels to utilize for off-channel scenarios, for example according to P2P tunneled direct link setup (TDLS) techniques. LTE-U aware STAs can further schedule high priority packets to avoid interference with LTE-U communications.

Moreover, LTE-U aware STAs can use the LTE-U measurement report for one or more of: selecting an operating channel, determining LTE-U interference levels, channels, and/or duty cycles, determining Modulation and Coding Scheme (MCS) and rate adaptation when aware of a concurrent LTE-U transmission, and/or applying Unscheduled Automatic Power Save Delivery (UAPSD) mechanisms to avoid transmissions from the AP 108 to itself during periods of LTE-U interference.

As discussed herein, LTE-U communication characteristic measurement and communication (for example, via the LTE-U measurement reports) can provide various advantages. For example, in various embodiments, WLAN devices can use knowledge of presence or potential LTE-U communication to make better channel selection decisions. Devices can augment their CCA to better perform dynamic BW selection (for example, on detecting LTE-U below ED on secondary channels). LTE-U timing information can be used to schedule off-channel behavior (for example, by a peer-to-peer (P2P) device to coincide with LTE-U activity time (using the LTE-U off-time for infrastructure access)

In various embodiments, WLAN devices can determine activity profile/medium utilization. LTE-U measurement reports can provide Radio Resource Management (RRM) statistics such as “LTE-U channel utilization factor,” which can be advertised by APs and used by devices to, for example, select an AP on that operating channel. Such statistics can be further augmented by the number of LTE-U BSs and/or networks detected.

In various embodiments, WLAN devices can learn location of LTE-U BS and apply Rx nulling schemes so as to allow the WLAN to Rx (for example, if associated to an AP which is unaware of LTE-U). In various embodiments, WLAN devices can embed training signals in a protection frame to allow WLAN devices to determine weights. In various embodiments, LTE-U measurement reports can allow faster means of WLAN channel switching.

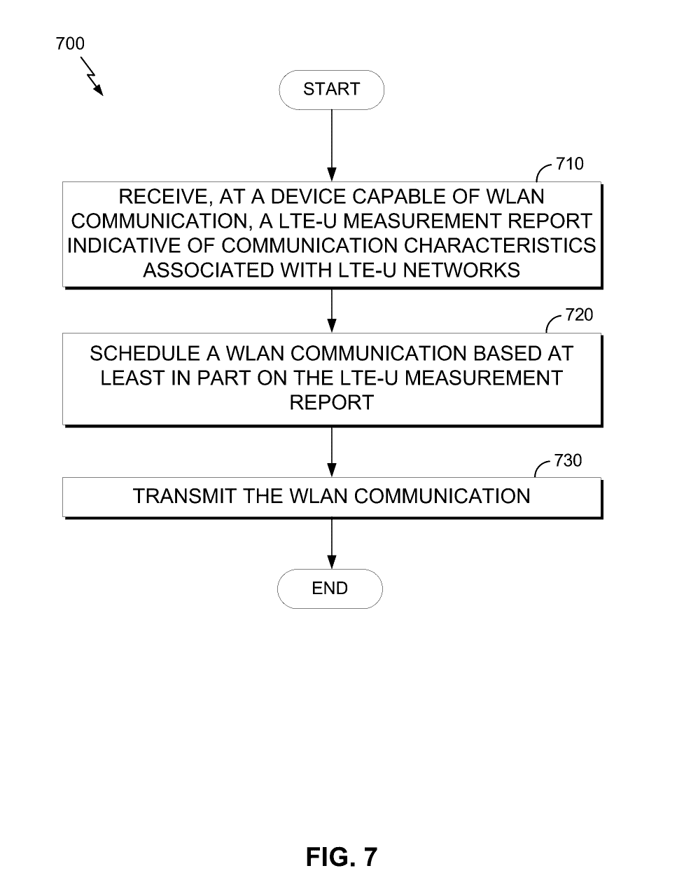

FIG. 7 shows a flowchart 700 for another example method of wireless communication that can be employed within wireless communication system 100 of FIG. 1. The method can be implemented in whole or in part by the devices described herein, such as wireless device 202 shown in FIG. 2. Although the illustrated method is described herein with reference to wireless communication system 100 discussed above with respect to FIG. 1 and communications 300-400 discussed above with respect to FIGS. 3-4, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 710, a wireless device capable of WLAN communication receives a LTE-U measurement report indicative of the LTE-U communication characteristics. For example, AP 108 or STA 120 can receive the LTE-U measurement report from UE 106. The LTE-U measurement report can include any of the LTE-U communication characteristics discussed herein and above in the section titled “LTE-U measurement report.” In some embodiments, the LTE-U measurement report can include an offset of the time of the LTE-U measurement report with respect to the LTE-U frame boundary. In some embodiments, the LTE-U measurement report can include an absolute time-stamp or time synchronization function (TSF) of the BSS of which the reporting device is part of at which the LTE-U frame is expected to start.

Then, at block 720, the wireless device schedules a WLAN communication based at least in part on the LTE-U measurement report. For example, when the wireless device is a STA (such as STA 120), it can make channel selection decisions, request off-channel operation schedules, transmitting one or more frames during an LTE-U idle period, determine a rate adaptation, and apply UAPSD mechanisms. As another example, when the wireless device is an AP (such as AP 108), it can perform channel selection, adjust TBTT or DTIM timing, transmit high-priority frames (such as beacons) during LTE-U idle periods, and schedule channel sounding packets for transmit beam-forming or multi-user MIMO transmissions.

In various embodiments, the WLAN device can receive another LTE-U measurement report. In various embodiments, the WLAN device can aggregate the LTE-U measurement report and the other LTE-U measurement report into an aggregated LTE-U measurement report. In various embodiments, the WLAN device can transmit the aggregated LTE-U measurement report to one or more other WLAN devices.

In various embodiments, the method can further include transmitting the aggregated LTE-U measurement report in response to a solicitation. In various embodiments, the method can further include transmitting the aggregated LTE-U measurement report unsolicited.

In various embodiments, the method can further include encoding the aggregated LTE-U measurement report in a vendor specific information element (IE). In various embodiments, the aggregated LTE-U measurement report can include LTE-U communication characteristics for more than one type of LTE-U network. In various embodiments the aggregated LTE-U measurement report may be transmitted unsolicited, for example as a WLAN public action frame. In various embodiments, the LTE-U measurement report may be transmitted as a WLAN action frame. In various embodiments, the aggregated LTE-U measurement report may be transmitted via WLAN data, management, or control frames.

In various embodiments, the method can further include limiting propagation of the aggregated LTE-U measurement report via a number of hops included in the LTE-U measurement report. In various embodiments, the method can further include transmitting field indicating LTE-U awareness. In various embodiments, the WLAN device can facilitate detection of the LTE-U Channel Usage Beacon Signal using an appropriate detector with the information contained in the CCA exempt transmissions (CET) signaling as contained in the LTE-U measurement report. In various embodiments, the transmitting can include broadcasting. In various embodiments, the transmitting can include transmitting to a particular device.

In an embodiment, the method shown in FIG. 7 can be implemented in a wireless device that can include a receiving circuit, a scheduling circuit, and a transmitting circuit. Those skilled in the art will appreciate that a wireless device can have more components than the simplified wireless device described herein. The wireless device described herein includes only those components useful for describing some prominent features of implementations within the scope of the claims.

The receiving circuit can be configured to receive the LTE-U measurement report. In some embodiments, the receiving circuit can be configured to perform at least block 710 of FIG. 7. The receiving circuit can include one or more of WLAN modem 238, receiver 212 (FIG. 2), antenna 216 (FIG. 2), and transceiver 214 (FIG. 2). In some implementations, means for receiving can include the receiving circuit.

The scheduling circuit can be configured to scheduling the WLAN transmission. In some embodiments, the scheduling circuit can be configured to perform at least block 720 of FIG. 7. The scheduling circuit can include one or more of processor 204 (FIG. 2), memory 206 (FIG. 2), and DSP 220 (FIG. 2). In some implementations, means for scheduling can include the scheduling circuit.

The transmitting circuit can be configured to transmit the WLAN communication. In some embodiments, the transmitting circuit can be configured to perform at least block 730 of FIG. 7. The transmitting circuit can include one or more of WLAN modem 238, transmitter 210 (FIG. 2), antenna 216 (FIG. 2), and transceiver 214 (FIG. 2). In some implementations, means for transmitting can include the transmitting circuit.

Referring again to FIG. 1, generally speaking, wireless communication system 100 provides a significant advantage in terms of providing communication services to the users. Wireless communication system 100 extends the benefits of LTE Advanced for operating in the unlicensed spectrum while being in coexistence with operation of WLAN (i.e., WiFi) system. The combined operations of LTE-U and WLAN in wireless communication system 100 improve wireless data traffic for including more connected devices and richer communication content. The wireless communication for the WLAN is carried out based on the protocols provided in one or more of the 802.11 Standards.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may include non-transitory computer readable medium (e.g., tangible media). In addition, in some aspects computer readable medium may include transitory computer readable medium (e.g., a signal). Combinations of the above should also be included within the scope of computer-readable media.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may include a computer program product for performing the operations presented herein. For example, such a computer program product may include a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of facilitating coexistence of wireless local area network (WLAN) devices and long term evolution unlicensed (LTE-U) devices in a communication network comprising a wireless device capable of both WLAN and LTE-U communication, comprising:
detecting one or more LTE-U networks and associated communication characteristics;
generating an LTE-U measurement report indicative of the LTE-U communication characteristics; and
transmitting the LTE-U measurement report to at least one WLAN device.

2. The method of claim 1, wherein the at least one WLAN device uses the LTE-U measurement report for one or more of: selecting an operating channel, determining LTE-U interference levels, channels, and/or duty cycles, ignoring errors at certain times while performing a rate adaptation, and scheduling high priority packets.

3. The method of claim 1, wherein the at least one WLAN device:
receives another LTE-U measurement report,
aggregates the LTE-U measurement report and the other LTE-U measurement report into an aggregated LTE-U measurement report, and
transmits the aggregated LTE-U measurement report to one or more other WLAN devices.

4. The method of claim 1, wherein the transmitting the LTE-U measurement report is unsolicited.

5. The method of claim 1, further comprising encoding the LTE-U measurement report in a vendor specific information element (IE).

6. The method of claim 1, wherein the LTE-U measurement report includes one or more of: a network name, a network identifier, a cell identifier, a regulatory domain, a list of occupied channels, a measured power level, an average LTE-U occupancy, a network type, a number of hops, an offset to a next carrier sensing adaptive transmission (CSAT) cycle start, a CSAT maximum on-time, a CSAT period, a notch duration, a notch period, an offset to LTE sub-frame boundary, an offset with respect to current sub-frame boundary, a number of sub-frames after which clear channel assessment (CCA) exempt transmission (CET) signaling repeats for uplink and downlink, a channel usage beacon signal (CUBS) identifier, a recommended CCA energy detection (ED) level, and a list of applicable channels.

7. The method of claim 1, wherein the LTE-U measurement report comprises LTE-U communication characteristics for more than one type of LTE-U network.

8. The method of claim 1, further comprising limiting propagation of the LTE-U measurement report via a number of hops indicated in the LTE-U measurement report.

9. The method of claim 1, further comprising transmitting one or more capability indications comprising one or more of: a field indicating LTE-U awareness, and a field indicating LTE-U measurement capability.

10. The method of claim 1, wherein the at least one WLAN device implements one or more channel usage beacon signal (CUBS) detectors that can receive CUBS identifiers obtained from the LTE-U measurement report.

11. A method of facilitating coexistence of wireless local area network (WLAN) devices and long term evolution unlicensed (LTE-U) devices in a communication network comprising a wireless device capable of WLAN communication, comprising:
receiving an LTE-U measurement report indicative of communication characteristics associated with LTE-U networks;
scheduling a WLAN communication based at least in part on the LTE-U measurement report; and
transmitting the WLAN communication.

12. The method of claim 11, wherein a WLAN device comprises a station and uses the LTE-U measurement report for one or more of: selecting an operating channel, determining LTE-U interference levels, channels, and/or duty cycles, ignoring errors at certain times while performing a rate adaptation, and scheduling high priority packets.

13. The method of claim 11, wherein a WLAN device comprises an access point and uses the LTE-U measurement report for one or more of: selecting an operating channel, adjusting a target beacon transmit time (TBTT) or a delivery traffic indication message (DTIM) timing, scheduling an off-channel operation, transmitting one or more frames during an LTE-U idle period, determining a rate adaptation, applying unscheduled automatic power save delivery coexistence (UAPSD) mechanisms, and scheduling channel sounding packets for beam-forming or multi-user MIMO transmissions.

14. The method of claim 11, further comprising:
receiving another LTE-U measurement report,
aggregating the LTE-U measurement report and the other LTE-U measurement report into an aggregated LTE-U measurement report, and
transmitting the aggregated LTE-U measurement report to one or more other WLAN devices.

15. The method of claim 11, wherein the LTE-U measurement report includes one or more of: a network name, a network identifier, a cell identifier, a regulatory domain, a list of occupied channels, a measured power level, an average LTE-U occupancy, a network type, a number of hops, an offset to a next carrier sensing adaptive transmission (CSAT) cycle start, a CSAT maximum on-time, a CSAT period, a notch duration, a notch period, an offset to LTE sub-frame boundary, an offset with respect to current sub-frame boundary, a number of sub-frames after which clear channel assessment (CCA) exempt transmission (CET) signaling repeats for uplink and downlink, a channel usage beacon signal (CUBS) identifier, a recommended CCA energy detection (ED) level, and a list of applicable channels.

16. The method of claim 14, further comprising encoding the aggregated LTE-U measurement report in a vendor specific information element (IE).

17. The method of claim 11, wherein the LTE-U measurement report comprises LTE-U communication characteristics for more than one type of LTE-U network.

18. The method of claim 14, further comprising limiting propagation of the aggregated LTE-U measurement report via a number of hops indicated in the aggregated LTE-U measurement report.

19. The method of claim 11, further comprising transmitting a field indicating LTE-U awareness.

20. The method of claim 11, further comprising providing channel usage beacon signal (CUBS) identifiers obtained from the LTE-U measurement report to one or more CUBS detectors.

21. An apparatus configured to facilitate coexistence of wireless local area network (WLAN) devices and long term evolution unlicensed (LTE-U) devices in a communication network comprising a wireless device capable of both WLAN and LTE-U communication, comprising:
a processor configured to:
detect one or more LTE-U networks and associated communication characteristics; and
generate an LTE-U measurement report indicative of the LTE-U communication characteristics; and
a transmitter configured to transmit the LTE-U measurement report to at least one WLAN device.

22. The apparatus of claim 21, wherein the at least one WLAN device uses the LTE-U measurement report for one or more of: selecting an operating channel, determining LTE-U interference levels, channels, and/or duty cycles, ignoring errors at certain times while performing a rate adaptation, and scheduling high priority packets.

23. The apparatus of claim 21, wherein the at least one WLAN device:
receives another LTE-U measurement report,
aggregates the LTE-U measurement report and the other LTE-U measurement report into an aggregated LTE-U measurement report, and
transmits the aggregated LTE-U measurement report to one or more other WLAN devices.

24. The apparatus of claim 21, wherein the LTE-U measurement report includes one or more of: a network name, a network identifier, a cell identifier, a regulatory domain, a list of occupied channels, a measured power level, an average LTE-U occupancy, a network type, a number of hops, an offset to a next carrier sensing adaptive transmission (CSAT) cycle start, a CSAT maximum on-time, a CSAT period, a notch duration, a notch period, an offset to LTE sub-frame boundary, an offset with respect to current sub-frame boundary, a number of sub-frames after which clear channel assessment (CCA) exempt transmission (CET) signaling repeats for uplink and downlink, a channel usage beacon signal (CUBS) identifier, a recommended CCA energy detection (ED) level, and a list of applicable channels.

25. An apparatus configured to facilitate coexistence of wireless local area network (WLAN) devices and long term evolution unlicensed (LTE-U) devices in a communication network comprising a wireless device capable of WLAN communication, comprising:
a receiver configured to receive an LTE-U measurement report indicative of communication characteristics associated with LTE-U networks;
a processor configured to schedule a WLAN communication based at least in part on the LTE-U measurement; and
a transmitter configured to transmit the WLAN communication.

26. The apparatus of claim 25, wherein the apparatus comprises a station and uses the LTE-U measurement report for one or more of: selecting an operating channel, determining LTE-U interference levels, channels, and/or duty cycles, ignoring errors at certain times while performing a rate adaptation, and scheduling high priority packets.

27. The apparatus of claim 25, wherein the apparatus comprises an access point and uses the LTE-U measurement report for one or more of: selecting an operating channel, adjusting a target beacon transmit time (TBTT) or a delivery traffic indication message (DTIM) timing, scheduling an off-channel operation, transmitting one or more frames during an LTE-U idle period, determining a rate adaptation, applying unscheduled automatic power save delivery coexistence (UAPSD) mechanisms, and scheduling channel sounding packets for beam-forming or multi-user MIMO transmissions.

28. The apparatus of claim 27, wherein the apparatus is further configured to:
receive, via the receiver, another LTE-U measurement report,
aggregate, via the processor, the LTE-U measurement report and the other LTE-U measurement report into an aggregated LTE-U measurement report, and
transmit, via the transmitter, the aggregated LTE-U measurement report to one or more other WLAN devices.

29. The apparatus of claim 25, wherein the LTE-U measurement report includes one or more of: a network name, a network identifier, a cell identifier, a regulatory domain, a list of occupied channels, a measured power level, an average LTE-U occupancy, a network type, a number of hops, an offset to a next carrier sensing adaptive transmission (CSAT) cycle start, a CSAT maximum on-time, a CSAT period, a notch duration, a notch period, an offset to LTE sub-frame boundary, an offset with respect to current sub-frame boundary, a number of sub-frames after which clear channel assessment (CCA) exempt transmission (CET) signaling repeats for uplink and downlink, a channel usage beacon signal (CUBS) identifier, a recommended CCA energy detection (ED) level, and a list of applicable channels.

30. The apparatus of claim 25, wherein the LTE-U measurement report comprises LTE-U communication characteristics for more than one type of LTE-U network.
